(19) United States
(12) Patent Application Publication
(10) Pub. No.: US 2008/0250121 A1
(43) Pub. Date: Oct. 9, 2008

(54) FACILITATING CONFIGURATION OF MULTIPLE INSTANCES OF AN APPLICATION ON A SERVER CLUSTER

(75) Inventor: Govindarajan Thirumalai, Bangalore (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 11/752,302

(22) Filed: May 23, 2007

(30) Foreign Application Priority Data
Apr. 9, 2007 (IN) 741/CHE/2007

(51) Int. Cl. G06F 15/177

(52) U.S. Cl. 709/220

(57) ABSTRACT

Facilitating configuration of multiple instances of an application executing in a server cluster. A centralized storage is provided at which configuration data for multiple application instances potentially executing on different servers (of a server cluster) is stored. The application instances may retrieve the configuration data from the centralized storage and operate using the data.

### RELATED APPLICATION

The present application is related to and claims priority from the co-pending India Patent Application entitled, “Facilitating Configuration Of Multiple Instances Of An Application On A Sever Cluster”, Serial Number: 741/CHE/2007, attorney docket number: ORCL-056, Filed: Apr. 9, 2007, naming the same inventors as in the subject patent application, and is incorporated in its entirety herewith.

### BACKGROUND

1. Technical Field

The present disclosure relates to server clusters and more specifically to facilitating configuration of multiple instances of an application.

2. Related Art

An application refers to a software program, which on execution performs specific tasks for users. It is often required to execute multiple instances of an application on a server cluster. A server cluster generally contains multiple server systems executing different instances of the same application.

The different instances/systems in a server cluster work together to appear as a single system to users. A server cluster is generally used to provide increased scalability (supporting more number of requests from users) and/or reliability (ensuring that a request is responded to even in the scenario when one of the instances is not executing).

The application instances typically need to be configured/customized based on, for example, the environment in which instances are being used, the specific user requirements, etc. There are often several portions of configuration, which is common for all the application instances and some portions are not common. For example, a group of users may require that an application instance be provided in a specific language or that the information be displayed in a particular format.

### BRIEF DESCRIPTION OF THE DRAWINGS

Example embodiments of the present invention will be described with reference to the accompanying drawings briefly described below.

FIG. 1 is a block diagram illustrating an example computing system in which various aspects of the present invention can be implemented.

FIG. 2 is a flowchart illustrating the manner in which configuration of multiple instances of an application is facilitated according to an aspect of the present invention.

FIG. 3 is a flowchart illustrating the manner in which application instances may be reconfigured according to an aspect of the present invention.

FIG. 4 is a flowchart illustrating the manner in which application instances may be self-configured according to an aspect of the present invention.

FIG. 5 depicts sample properties stored in a configuration data and used to configure application instances in an embodiment.

FIG. 6 is a block diagram illustrating the details of a configuration manager in an embodiment.

FIG. 7 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. OVERVIEW

An aspect of the present invention provides a centralized storage at which configuration data for multiple application instances, potentially executing on different servers of a server cluster, is stored. The application instances may retrieve the configuration data from the centralized storage and operate using the data. Due to the centralized storage, administration of the multiple application instances may be simplified.

According to another aspect of the present invention, the configuration data is stored as individual properties identified by names and having corresponding values. A central configuration manager may receive from an application instance a request specifying the names of some of the properties. The configuration manager may retrieve the values of the requested names and send a response containing the values.

In an embodiment, the configuration data includes different values for the same property depending on a locale (typically geography/language of the users using the application instance). Thus, a configuration manager may receive a request specifying a locale, and the values may be retrieved based on the locale associated with each property.

According to one more aspect of the present invention, an application instance is notified when a value of a property is modified. The application instance may in turn operate thereafter using the changed value.

According to yet another aspect of the present invention, an application instance is designed to perform self-configuration (and thereby define/change operation). A request is sent to a property manger for properties needed for self-configuration. On receiving the values of the properties from the configuration manager, the received values are used to perform self-configuration.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. EXAMPLE ENVIRONMENT

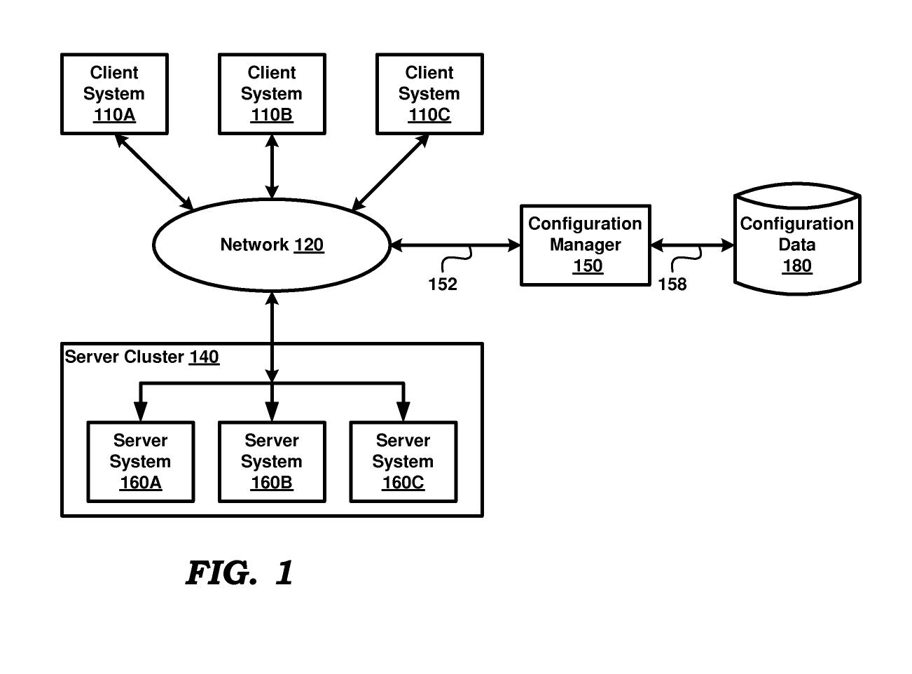

FIG. 1 is a block diagram illustrating an example computing system in which various aspects of the present invention can be implemented. The block diagram is shown containing client systems 110A-110C, network 120, server cluster 140 (containing server systems 160A-160C), configuration manager 150 and configuration data 180. Merely for illustration, only representative number/type of systems are shown in the Figure. Many environments often contain many more systems, both in number and type, depending on the purpose for which the environment is designed. Each system/device of FIG. 1 is described below in further detail.

Network 120 provides connectivity between various client systems 110A-110C, server cluster 140 and configuration manager 150. Network 120 may be implemented using protocols such as Internet Protocol (IP) well known in the relevant arts.

Configuration data 180 facilitates storage and retrieval of properties used for configuration of applications and may be stored in a database server. Each property may be identified by a name and an associated value may also be stored. In one embodiment, configuration data 180 represents a database server, which facilitates storage and retrieval of a collection of data using structured queries such as SQL in the case of relational database technologies.

Each of client systems 110A-110C represents a system such as a personal computer, workstation, mobile station, etc., and is used by a user to generate requests to applications executed in server cluster 140. The requests may be generated according to a suitable interface. In general, a client system requests the application for performing operations (e.g., a transaction or retrieval of a desired content) and receives corresponding responses containing the results of performance of the requested operations.

Server cluster 140 contains one or more physical systems (e.g., server systems 160A-160C) to execute multiple instances of an application (“application instances”) simultaneously. Though not shown, server cluster 140 may contain components such as load balancers, which assigns each received request to one of the server systems.

In one embodiment, different instances of an application are executed on different physical systems (server systems 160A-160C). Each of server systems 160A-160C represents a system, which executes different instances of the same application capable of performing operations requested by client systems 110A-110C. The results of the operations are sent as corresponding responses to the requesting client systems.

Configuration manager 150 enables the different instances of the same application executing in server systems 160A-160C to be configured in a similar manner as described with examples below.

### 3. FACILITATING CONFIGURATION OF MULTIPLE INSTANCES

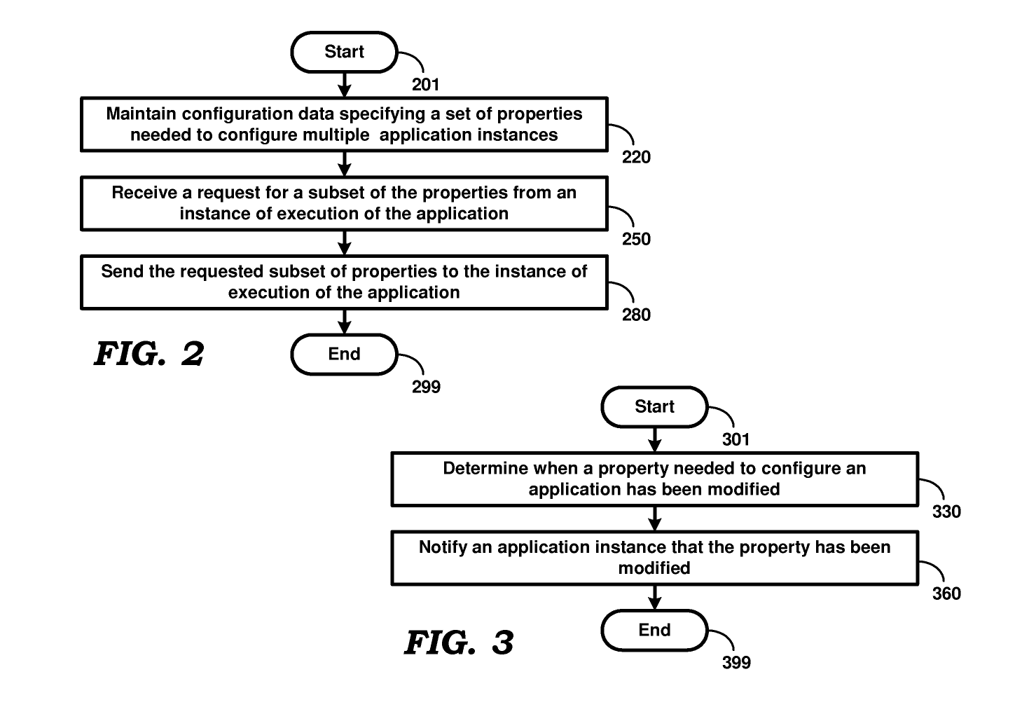

FIG. 2 is a flowchart illustrating the manner in which configuration of multiple instances of an application is facilitated according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 201, in which control immediately passes to step 220.

In step 220, configuration manager 150 maintains configuration data specifying a set of properties needed to configure multiple application instances. Each property may have an associated name and value. The set of properties may be stored in configuration data 180.

In step 250, configuration manager 150 receives a request for a subset of the properties from an application instance. The application instance may be executing on one of server systems 160A-160C (in server cluster 140). The request may specify the names of the properties required to configure the application instance.

In step 280, configuration manager 150 sends the requested subset of properties to the application instance. The values corresponding to the names specified in the request received in step 250 are retrieved from configuration data 180 and sent as the response. The values may be used by the requesting application instance for configuration (or used otherwise). The flow chart ends in step 299.

Thus, the properties used in the configuration of an application are maintained and made accessible to the various application instances. It may be appreciated that in a scenario when one of the properties is modified, the operation of the several application instances may also need to change for accurate operation. The manner in which application instances may be reconfigured is described below with examples.

### 4. PROVIDING RECONFIGURATION

FIG. 3 is a flowchart illustrating the manner in which application instances may be reconfigured according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence other than that described below, as suited in the specific environment, as will be apparent to one skilled in the relevant arts. Many of such implementations are contemplated to be covered by several aspects of the present invention. The flow chart begins in step 301, in which control immediately passes to step 330.

In step 330, configuration manager 150 determines when a property needed to configure an application has been modified. The determination can be performed in various ways, depending on the specific environment. For example, the properties may be modified by one of the application instances. The instance may send a change request specifying the names of the properties and the corresponding new values to configuration manager 150, which may then update configuration data 180 with the new values. Completion of the change may form the basis for the determination that the property has been modified.

Alternatively, the properties may be modified by an administrator using one of clients system 110A-110C. The administrator may be provided with a suitable interface using which the administrator may upload a new set of properties to configuration data 180 directly. Configuration manager 150 may then receive an indication from configuration data 180 about the modification.

In step 360, configuration manager 150 notifies an application instance that the property has been modified. The specific instance notified may be determined using various approaches. For example, each of the application instances may be notified of the modification. Alternatively, the identifiers of each application instance requesting a property may be maintained, and the change notification may be sent only to the specific application instances.

The notification may contain the new value of the property. Alternatively, upon receiving the notification, an application instance may request for the values of properties from configuration manager 150, and use the properties received in response to perform re-configuration. The flow chart ends in step 399.

It may be appreciated that by providing the properties needed to configure an application and notifying the modifications made to the properties, application instances may operate with new values. For example, the application instances may engage in self-configuration as described with examples below.

### 5. ENABLING SELF-CONFIGURATION

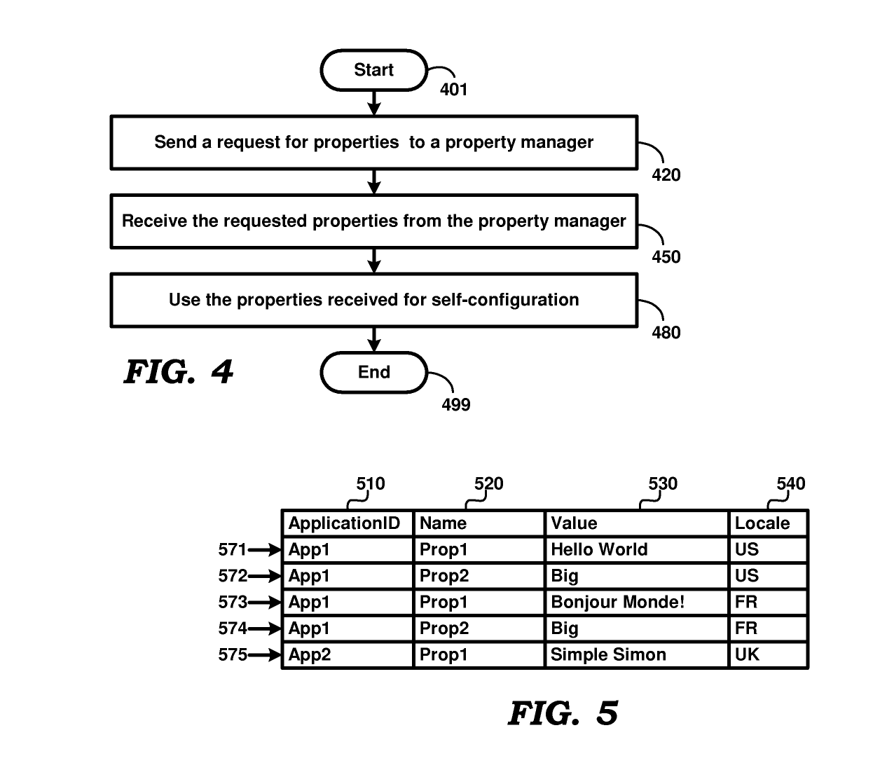

FIG. 4 is a flowchart illustrating the manner in which application instances may be self-configured according to an aspect of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 401, in which control immediately passes to step 420.

In step 420, an application instance sends a request for properties to configuration manager 150. The request may specify the names of the properties needed from configuration manager 150. The request may be sent by the application instance when the instance is initialized or when a notification is received indicating that the properties need to self-configure have been modified (as described in step 360).

In step 450, the application instance receives the requested properties from configuration manager 150. The received information contains the values corresponding to the names of the properties specified in the request. The names of the properties may also be received in the response. It should be appreciated that the properties may be received without sending the request of step 420, for example, when the value of the property changes. Step 480 described below may be performed in such situations as well.

In step 480, the application instance uses the properties received for self-configuration. The self-configuration may be performed by storing the values in appropriate locations (e.g., registers, memory, local secondary storage) according to a pre-specified convention. Application instances may need to be designed consistent with the convention such that operation thereafter reflects the new values. The flow chart ends in step 499.

Thus, the self-configuration may be potentially performed without re-initializing the application instance. Such a feature may be desirable in ensuring continuity in performing operations requested by users from client systems 110A-110C. The description is continued describing the manner in which properties are maintained in an embodiment.

### 6. CONFIGURATION DATA

FIG. 5 depicts sample properties stored in configuration data 180 and used to configure application instances in an embodiment.

Broadly, properties for different applications (each having corresponding application instances) are maintained in configuration data 180. Each of the properties is associated with a corresponding application identifier identifying the application whose configuration (or operation otherwise) requires the property. An application instance may then have to specify the application identifier in the request identifying the application corresponding to which the properties are to be retrieved.

Various types of information may be maintained in configuration data depending on the specific environment, as will be apparent to one skilled in the relevant arts by reading the disclosure provided herein. In an embodiment, the configuration data may be viewed as containing system specific properties and user interface properties. System specific properties generally specify information defining the details/topology of the network such as the network addresses of the various server systems in the server cluster, the user name and password required to access a database system, the network address of a dynamic name server (DNS server) enabling network name to IP/network address translation.

User interface properties represent the properties, which affect the user experience when a user is using one of the application instances. As an illustration, the properties may include default values of properties, which can be overridden by individual users (for user's own context only) using interfaces provided by application instances. Examples of such properties include default fonts, font types, color, etc., which may be frequently modified/accessed.

The user interface properties may also specify the manner in which user interface elements are presented to a user/group of users using the corresponding application instances. Such properties may specify the text to be displayed (based on the language/culture of the user), the size and location of the various interface elements (based on the size of the display). Such interface specific properties may be provided by an application developer to enable configuration of the application (instances) based on the requirements of a user/group of users using the application.

Further, it may be appreciated that server cluster 140 may be designed to distribute requests received from different sets of users to different instances of application, for example, based on the language/geography of the corresponding set of users. Such localized considerations are referred to as a locale. As such, it may be required that each of the application instances be configured with corresponding properties (based on locale). In such a scenario, each of the properties is also associated with a corresponding locale and retrieval of properties from configuration data 180 may be performed based on a specific locale specified in the request.

Though each of the properties is shown associated with an application identifier identifying the application to be configured and a locale identifying the user environment, in alternative embodiments, the properties may be maintained in any convenient form. For example, properties corresponding to each application (or to each combination of application and locale) may be stored in separate tables in the database.

Continuing with respect to FIG. 5, column 510 (labeled “ApplicationID”) identifies the application that can be configured corresponding to each of the properties. Column 520 (labeled “Name”) uniquely identifies each property used to configure the application specified by column 510. Column 530 (labeled “Value”) depicts the value of the property identified by the name. Column 540 (labeled “Locale”) identified the locale associated with each property. It may be observed that the combination of “ApplicationID”, “Locale” and “Name” uniquely identifies each property in the table.

Each of rows 571-575 specifies properties used for configuration. In particular, row 571 specifies a property with name “Prop1” having a value of “Hello World” for the locale “US” used to configure the application identified by the identifier “App1”. Similarly row 572 specifies another property “Prop2” (with value “Big”) for the same application “App1” and the same locale “US”. Rows 573 and 574 specify alternate values (“Bonjour Monde!” and “Big”) for the locale “FR” for the properties specified in respective rows 571 and 572. Row 575 specifies a property with the same name as the property specified in row 571, but for a different application “App2” and for a different locale “UK”.

The description is continued with respect to an example implementation of configuration manager 150.

### 7. CONFIGURATION MANAGER

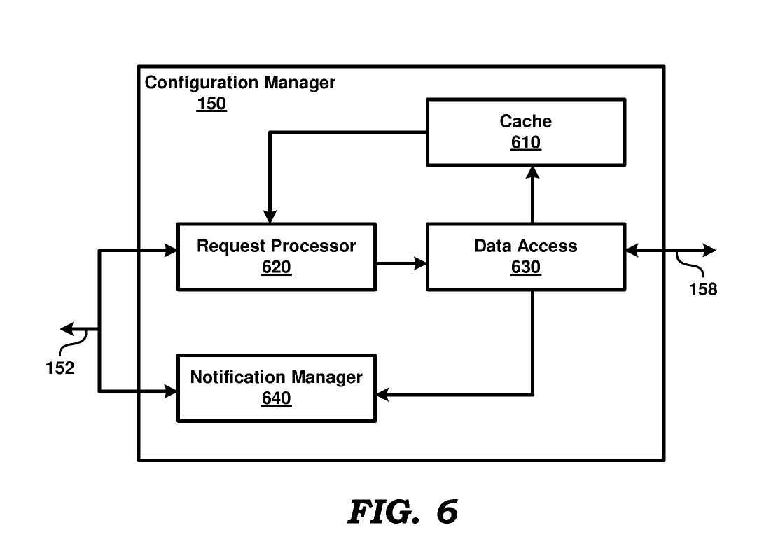

FIG. 6 is a block diagram illustrating the details of configuration manager 150 in an embodiment. The block diagram is shown with cache 610, request processor 620, data access 630, and notification manager 640. Each block is described below.

Cache 610 represents a temporary storage where properties are stored for speedier access of configuration data. Recently accessed properties (retrieved from configuration data 180 during the processing of previous requests) may be stored in cache 610. Each of the properties stored in cache 610 is associated with a flag indicating whether the cached property reflects the corresponding property stored in configuration data 180.

Request processor 620 receives requests (via path 152) for properties (corresponding names) from multiple instances of an application. Request processor 620 first verifies whether the values of the properties requested are available in cache 610 and also verifies that the values reflect the current/present values in configuration data 180 (by inspecting the flags associated with the properties).

In the scenario that the values corresponding to the names are present and reflect the present values in configuration data 180, request processor 620 retrieves the values and sends the retrieved values as the response to the requesting application instance. Alternatively, if the values for the properties are not present, request processor 620 indicates to data access 630 to retrieve values corresponding to the properties.

Data access 630 stores/retrieves properties from (and provides an interface to) configuration data 180 (via path 158) and therefore is implemented consistent with the implementation of (server implementing) configuration data 180. On receiving an indication from request processor 620, data access 630 generates and sends appropriate queries to configuration data 180. Data access 630 then receives the response to the queries and stores the retrieved properties in cache 610. It may be appreciated that data access 630 may perform appropriate transformations on the properties received from configuration data 180 before storing the properties in cache 610.

Data access 630 also receives indications from configuration data 180 when the properties stored in configuration data 180 are modified. On receiving such an indication, data access 630 first queries configuration data 180 about the names of the modified properties. Data access 630 then sets the flag associated with the modified properties in cache 610, thereby indicating to request processor 620 that the flagged properties are to be retrieved again. Data access 630 further indicates to notification manager 640 about the modification of properties stored in configuration data 180.

Notification manager 640 receives an indication from data access 630 that the properties stored in configuration data 180 have been modified. On receiving such an indication, notification manager 640 sends notifications to each of the application instances (via path 152). It may be appreciated that to enable notification manager 640 to notify the various instances, it may be required to maintain data (not shown) indicating the multiple application instances.

It should be appreciated that the features described above can be implemented in various embodiments as a desired combination of one or more of hardware, software and firmware. The description is continued with respect to an embodiment in which various features are operative when software instructions are executed.

### 8. DIGITAL PROCESSING SYSTEM

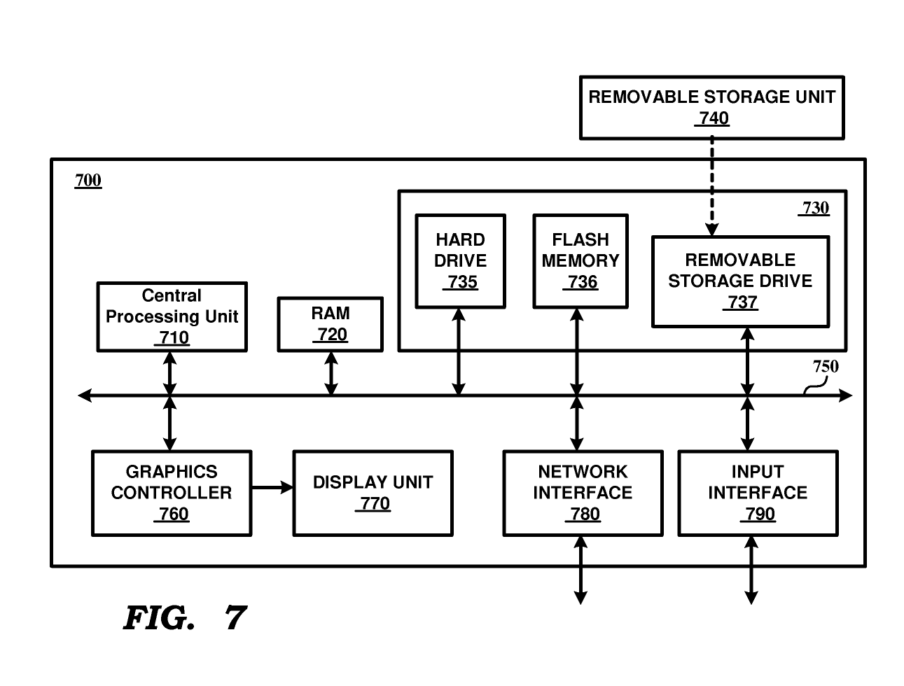

FIG. 7 is a block diagram illustrating the details of digital processing system 700 in which various aspects of the present invention are operative by execution of appropriate software instructions. Digital processing system 700 may correspond to configuration manager 150 or one of server systems 160A-160C. Digital processing system 700 may contain one or more processors (such as a central processing unit (CPU) 710), random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general purpose processing unit. RAM 720 may receive instructions from secondary memory 730 using communication path 750.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse). Network interface 780 provides connectivity to a network (e.g., using Internet Protocol), and may be used to communicate with other connected systems (such as client systems 110A-110C and server cluster 140) of FIG. 1.

Secondary memory 730 may contain hard drive 735, flash memory 736, and removable storage drive 737. Secondary memory 730 may store the data (e.g., portions of data depicted in FIG. 5) and software instructions, which enable digital processing system 700 to provide several features in accordance with the present invention. Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present invention described above.

### 9. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A computing system comprising:
a server cluster containing a plurality of servers executing a plurality of instances of an application, wherein each of said plurality of instances require configuration data for operation; and
a configuration manager providing said configuration data to said plurality of servers.

2. The computing system of claim 1, wherein said configuration data comprises a plurality of properties, wherein said each of said plurality of instances sends a corresponding request specifying a corresponding subset of properties, wherein each of said subset of properties is contained in said plurality of properties,
wherein said configuration manager sends a corresponding response containing the requested subset of properties to each of the corresponding instances.

3. The computing system of claim 2, wherein said configuration manager determines that a first property contained in said plurality of properties has been modified,
wherein said configuration manager notifies a corresponding first instance that said first property has been modified, wherein said first instance is contained in said plurality of instances.

4. The computing system of claim 2, wherein each of said plurality of properties is identified by a name and is associated with a corresponding value,
wherein said request contains names corresponding to each of said subset of properties and said corresponding response contains values corresponding to said names.

5. The computing system of claim 4, wherein each of said plurality of properties is associated with a locale,
wherein said request further contains a specific locale for said subset of properties, wherein said corresponding response sends values corresponding to said names and said specific locale.

6. The computing system of claim 5, wherein said configuration data is stored in a non-volatile memory, wherein said configuration manager sends said corresponding response after retrieving said values corresponding to said names from said non-volatile memory.

7. The computing system of claim 6, wherein said non-volatile memory comprises a database.

8. The computing system of claim 2, wherein each of said request received from said corresponding plurality of instances further specifies an application identifier identifying said application.

9. The computing system of claim 2, wherein said plurality of properties specifies a manner in which said application is to be customized for a group of users.

10. The computing system of claim 2, wherein said plurality of properties specify values to be used in generating a user interface displayed to users of said plurality of instances of said application.

11. A method of facilitating configuration of a plurality of instances of an application executing on a server cluster, said method being implemented in a configuration manager, said method comprising:
maintaining configuration data specifying a plurality of properties required in configuration of said application;
receiving a request containing a subset of properties from a first instance of said application, wherein said subset of properties is contained in said plurality of properties and said first instance is contained in said plurality of instances; and
sending said subset of properties to said first instance.

12. The method of claim 11, further comprising:
determining that a first property contained in said subset of properties has been modified; and
notifying said first instance that said first property has been modified.

13. The method of claim 11, wherein each of said plurality of properties is identified by a name and is associated with a corresponding value, wherein said receiving receives names corresponding to each of said subset of properties and said sending sends values corresponding to said names.

14. The method of claim 13, wherein each of said plurality of properties is associated with a locale, wherein said request further contains a specific locale for said subset of properties, wherein said sending sends values corresponding to said names and said specific locale.

15. The method of claim 14, wherein said maintaining maintains said plurality of properties in a non-volatile memory, wherein said sending sends said subset of properties after retrieving from said non-volatile memory.

16. The method of claim 15, wherein said non-volatile memory comprises a database.

17. The method of claim 11, wherein said request further specifies an application identifier identifying said application, wherein said sending sends said subset of properties based on said application identifier.

18. A machine readable medium carrying one or more sequences of instructions for causing a system to facilitate configuration of a plurality of instances of an application executing on a server cluster, wherein execution of said one or more sequences of instructions by one or more processors contained in said system causes said system to perform the actions of:
maintaining configuration data specifying a plurality of properties required in configuration of said application;
receiving a request containing a subset of properties from a first instance of said application, wherein said subset of properties is contained in said plurality of properties and said first instance is contained in said plurality of instances; and
sending said subset of properties to said first instance.

19. The machine readable medium of claim 18, further comprising one or more instructions for:
determining that a first property contained in said subset of properties has been modified; and
notifying said first instance that said first property has been modified.

20. The machine readable medium of claim 18, wherein each of said plurality of properties is identified by a name and is associated with a corresponding value, wherein said receiving receives names corresponding to each of said subset of properties and said sending sends values corresponding to said names.

21. The machine readable medium of claim 20, wherein each of said plurality of properties is associated with a locale, wherein said request further contains a specific locale for said subset of properties, wherein said sending sends values corresponding to said names and said specific locale.

22. The machine readable medium of claim 21, wherein said maintaining maintains said plurality of properties in a non-volatile memory, wherein said sending sends said subset of properties after retrieving from said non-volatile memory.

23. The machine readable medium of claim 22, wherein said non-volatile memory comprises a database.

24. The machine readable medium of claim 18, wherein said request further contains an application identifier identifying said application, wherein said sending sends said subset of properties based on said application identifier.
